(19) United States
(12) Patent Application Publication
(10) Pub. No.: US 2025/0390985 A1
(43) Pub. Date: Dec. 25, 2025

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: Yuichi NAKADA, Kanagawa (JP)

(21) Appl. No.: 19/235,855

(22) Filed: Jun. 12, 2025

(30) Foreign Application Priority Data
Jun. 24, 2024 (JP) 2024-101067

(51) Int. Cl. G06T 3/4046; G06T 15/20

(52) U.S. Cl. CPC G06T 3/4046; G06T 15/20

(57) ABSTRACT

An object is to estimate three-dimensional information capable of generating virtual viewpoint images with high image quality while reducing the number of learning parameters for the estimation of the three-dimensional information. An image processing apparatus: obtains a plurality of captured images obtained by image capturing of an image capturing region from a plurality of directions; sets at least one partial region in the image capturing region; sets a learning model corresponding to the partial region such that the higher a pixel resolution for the partial region in each of the plurality of captured images, the larger the number of learning parameters per volume; and trains the learning model by using the plurality of captured images.

### BACKGROUND

### Field

The present disclosure relates to a technology for estimating three-dimensional information on a space including an object.

### Description of the Related Art

There has been a technology that estimates information on a space including an object (hereinafter referred to as “three-dimensional information”) by using images obtained by image capturing of the object performed from various directions (hereinafter referred to as “captured images”). There has also been a technology that generates an image corresponding to a representation of an object as seen from any imaginary viewpoint (hereinafter referred to as “virtual viewpoint”) by using three-dimensional information (such an image will hereinafter be referred to as “virtual viewpoint image”). Japanese Patent Laid-Open No. 2023-066705 (hereinafter referred to as “Patent Document 1”) discloses a technology that uses captured images as training images to train a radiance field as three-dimensional information that indicates position- and direction-dependent colors and densities in a space including an object. Also, Patent Document 1 discloses a technology that generates a virtual viewpoint image by volume rendering using a radiance field estimated by the above training.

Specifically, the technology disclosed in Patent Document 1 (hereinafter referred to as “conventional technology”) performs machine learning through sampling at points on rays corresponding to respective pixels of each training image to calculate learning parameters for the radiance field. More specifically, in this calculation, the sampling densities on the rays corresponding to the respective pixels of each training image within the depth of field are made higher than the sampling densities outside the depth of field. By controlling the sampling densities based on the depth of field, the conventional technology improves the accuracy of estimation of the radiance field of the space corresponding to the object within the depth of field while reducing the amount of computation for estimating the radiance field, and accordingly improves the image quality of virtual viewpoint images.

### SUMMARY

An inventor realized that the conventional technology includes a problem that, in a case where the number of learning parameters (hereinafter referred to as “learning parameter count”) is small for the resolution of the captured images, it lowers the accuracy of estimation of the radiance field of the space corresponding to the object, which consequently lowers the image quality of virtual viewpoint images. Incidentally, the image quality of virtual viewpoint images is limited by the image quality of the captured images. For this reason, the inventor realized that simply increasing the learning parameter count does not change the image quality of virtual viewpoint images and just increases the amount of computation required to estimate the three-dimensional information and the amount of information in the three-dimensional information.

Thus, an object of the present disclosure is to provide a technology for estimating three-dimensional information capable of generating virtual viewpoint images with high image quality while reducing the learning parameter count for the estimation of the three-dimensional information.

An image processing apparatus according to the present disclosure includes: one or more hardware processors; and one or more memories storing one or more programs configured to be executed by the one or more hardware processors, the one or more programs including instructions for: obtaining a plurality of captured images obtained by image capturing of an image capturing region from a plurality of directions; setting at least one partial region in the image capturing region; setting a learning model corresponding to the partial region such that the higher a pixel resolution for the partial region in each of the plurality of captured images, the larger the number of learning parameters per volume; and training the learning model by using the plurality of captured images.

Features of the present disclosure will become apparent from the following description of embodiments with reference to the attached drawings. The following description of embodiments are described by way of example.

### BRIEF DESCRIPTION OF THE DRAWINGS

FIG. 1 is a diagram illustrating an example of an image processing system according to a first embodiment;

FIG. 2 is a block diagram illustrating an example of a hardware configuration of an image processing apparatus according to the first embodiment;

FIG. 3 is a block diagram illustrating an example of a functional configuration of the image processing apparatus according to the first embodiment;

FIG. 4 is a flowchart illustrating an example of a flow of processing by the image processing apparatus according to the first embodiment;

FIG. 5A is a diagram illustrating an example of a layout of image capturing apparatuses according to the first embodiment, and FIGS. 5B to 5D are diagrams illustrating an example of captured images to the first embodiment;

FIG. 6 is a flowchart illustrating an example of a flow of partial region setting processing by a region setting unit according to the first embodiment;

FIG. 7 is a diagram illustrating an example of a partial region set by the region setting unit according to the first embodiment;

FIG. 8 is a flowchart illustrating an example of a flow of pixel resolution setting processing by a resolution setting unit according to the first embodiment;

FIG. 9 is a diagram for describing an example of a reference point distance according to the first embodiment;

FIG. 10 is a flowchart illustrating an example of a flow of learning model setting processing by a model setting unit according to the first embodiment;

FIGS. 11A and 11B are diagrams for describing an example of the learning model setting processing by the model setting unit according to the first embodiment;

FIGS. 12A and 12B are diagrams illustrating an example of partial regions according to the first embodiment;

FIG. 13 is a diagram illustrating an example of partial regions according to a modification of the first embodiment;

FIGS. 14A and 14B are diagrams for describing an example of the learning model setting processing by the model setting unit according to a modification of the first embodiment;

FIGS. 15A and 15B are diagrams illustrating an example of division of a partial region and integration of partial regions according to a modification of the first embodiment;

FIG. 16 is a flowchart illustrating an example of a flow of pixel resolution setting processing by a resolution setting unit according to a second embodiment;

FIG. 17 is a diagram for describing an example of the pixel resolution setting processing by the resolution setting unit according to the second embodiment;

FIG. 18 is a flowchart illustrating an example of a flow of learning model setting processing by a model setting unit according to the second embodiment; and

FIGS. 19A to 19D are diagrams for describing an example of the learning model setting processing by the model setting unit according to the second embodiment.

### DESCRIPTION OF THE EMBODIMENTS

Hereinafter, with reference to the attached drawings, the present invention is explained in detail in accordance with preferred embodiments. Configurations shown in the following embodiments are merely exemplary and the present invention is not limited to the configurations shown schematically.

### First Embodiment

A first embodiment will describe a mode for training a radiance field corresponding to a space including an object based on data of captured images obtained by image capturing of the object performed from various directions with a plurality of image capturing apparatuses (hereinafter referred to as “captured image data”). Specifically, the above training according to the present embodiment is performed on a learning model that is set based on the pixel resolutions of image regions in the captured images corresponding to the space including the object.

### <Configuration of Image Processing System>

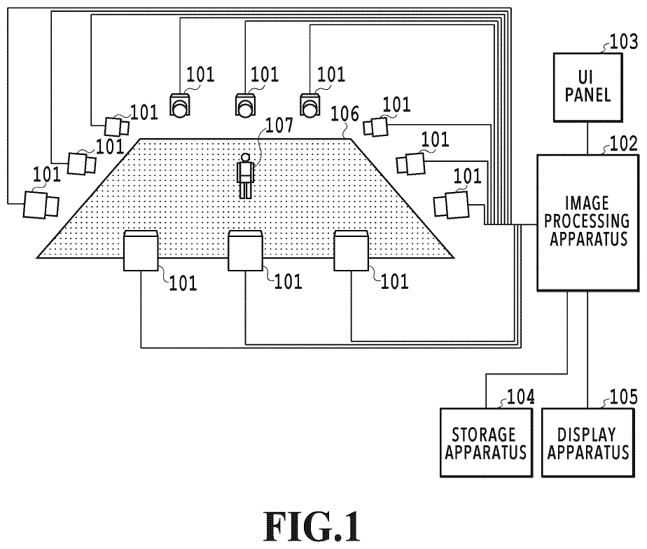

FIG. 1 is a diagram illustrating an example of an image processing system according to the first embodiment. The image processing system has a plurality of image capturing apparatuses 101, an image processing apparatus 102, a user interface (hereinafter referred to as “UI”) panel 103, a storage apparatus 104, and a display apparatus 105. The plurality of image capturing apparatuses 101 include digital still cameras, digital video cameras, or the like, and are placed at different positions. The image capturing apparatuses 101 capture images of an object 107 present in an image capturing region 106 from various directions under preset image capturing conditions in synchronization with each other, and output captured image data obtained by this image capturing to the image processing apparatus 102.

Note that the synchronized image capturing means capturing images with synchronization processing. That is, the synchronized image capturing includes not only image capturing operations performed at exactly the same time, and also includes image capturing operations performed at substantially the same time. Also, the captured image data obtained by the image capturing by the image capturing apparatuses 101 may be data of still images or data of moving images or data of both still images and moving images. The following description will be given on the assumption that the term “image” has meanings of both “still image” and “moving image,” unless otherwise noted.

The image processing apparatus 102 obtains the plurality of pieces of captured image data output from the plurality of image capturing apparatuses 101, and performs training on information on the three-dimensional shape and color of a space including the object 107 present in the image capturing region 106 (three-dimensional information) by using the obtained plurality of pieces of captured image data. Also, the image processing apparatus 102 generates a virtual viewpoint image based on the three-dimensional information obtained as a result of the training (hereinafter referred to as “learned three-dimensional information”).

Note that while the present embodiment will be exemplarily described on the assumption that the training-target three-dimensional information is a function representing a radiance field constructed by multi-layer perceptrons, the method of representing the training-target three-dimensional information varies depending on the contents of the training. Specifically, the three-dimensional information may be one represented by, for example, Instant Neural Graphics Primitives (NGP). Also, the three-dimensional information is not limited to one constructed by multi-layer perceptrons, and may be represented by Plenoxels or Tensorial Radiance Fields (TensoRF), which explicitly provide three-dimensional representations, or the like. Also, the three-dimensional information may be represented by Neural Surface Reconstruction (NeuS), which provides improved accuracy in shape estimation the signed distance field (SDF), or the like. Also, the three-dimensional information may be represented by various techniques, such as 3D Gaussian Splatting, such that the three-dimensional representation is provided by a set of points with spatial extent.

Note that the present embodiment will be described on the assumption that each of the plurality of image capturing apparatuses 101 and the image processing apparatus 102 are connected to each other as illustrated in FIG. 1, but how the image capturing apparatuses 101 and the image processing apparatus 102 are connected to each other is not limited to this. Specifically, for example, the image capturing apparatuses 101 located adjacent to each other may be connected to thereby cascade the plurality of image capturing apparatuses 101, and at least one of the plurality of image capturing apparatuses 101 may be connected to the image processing apparatus 102.

Also, the present embodiment will be described on the assumption that the plurality of image capturing apparatuses 101 are placed at different positions as illustrated in FIG. 1 as an example, the number and layout of the image capturing apparatuses 101 are not limited to this example. For example, in a case where the position, shape, and color of the object 107 present in the image capturing region 106, the intensity or color of the ambient light, and so on do not change over time, at least one image capturing apparatus 101 whose position and orientation are changeable may be placed. In this case, this image capturing apparatus 101 may be caused to capture an image at each of a plurality of different positions while the position and orientation of the image capturing apparatus 101 are changed, and the image processing apparatus 102 may obtain the plurality of pieces of captured image data obtained by this image capturing.

A UI panel 103 includes a display device, such as a liquid crystal panel, and displays on this display device a graphical user interface (GUI) for presenting information to the user, such as image capturing conditions for the image capturing apparatuses 101 and processing settings of the image processing apparatus 102. Also, the UI panel 103 may include an input device, such as a touch panel or buttons, in which case the UI panel 103 receives instructions from the user for changing the image capturing conditions or processing settings mentioned above and for performing other operations. The input device may be provided as a separate body from the UI panel 103, such as a mouse or a keyboard.

The storage apparatus 104 includes a hard disk drive or the like, and stores data of virtual viewpoint images output from the image processing apparatus 102. In a case where the image processing apparatus 102 outputs three-dimensional information, the storage apparatus 104 may store the three-dimensional information output from the image processing apparatus 102. The display apparatus 105 includes a liquid crystal display or the like, and obtains image signals representing virtual viewpoint images output from the image processing apparatus 102 and displays the virtual viewpoint images corresponding to the image signals. In a case where the image processing apparatus 102 outputs image signals representing three-dimensional information, the display apparatus 105 may obtain the image signals representing the three-dimensional information output from the image processing apparatus 102 and display images corresponding to these image signals. The image capturing region 106 is a three-dimensional space surrounded by the plurality of image capturing apparatuses 101 installed in a studio or the like. In FIG. 1, the frame depicted with a solid line represents the outline of the image capturing region 106 on the floor surface.

### <Hardware Configuration of Image Processing Apparatus>

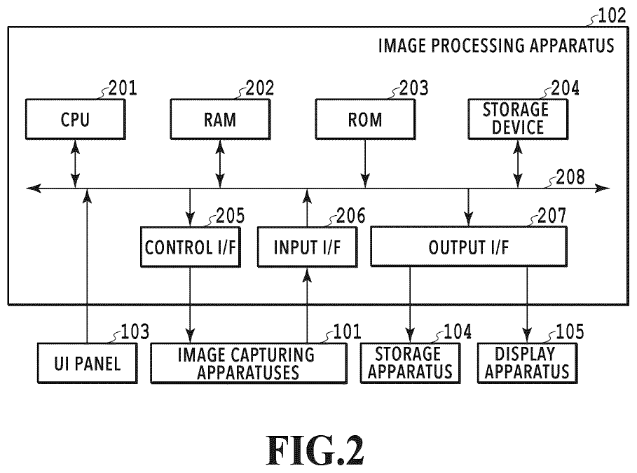

FIG. 2 is a block diagram illustrating an example of a hardware configuration of the image processing apparatus 102 according to the first embodiment. The image processing apparatus 102 has a central processing unit (CPU) 201, a random-access memory (RAM) 202, a read-only memory (ROM) 203, a storage device 204, a control interface (hereinafter referred to as “I/F”) 205, an input I/F 206, an output I/F 207, and a main bus 208 as its hardware components. The CPU 201 is a processor that comprehensively controls elements of the image processing apparatus 102. The RAM 202 functions as a main memory, a work area, and the like for the CPU 201. A read-only memory (ROM) 203 stores a set of programs to be executed by the CPU 201. The storage device 204 includes a hard disk drive or the like, and stores application programs to be executed by the CPU 201, data to be used in processes by the CPU 201, and so on.

The control I/F 205 is connected to each image capturing apparatus 101, and is a communication interface for controlling the setting of the image capturing conditions for each image capturing apparatus 101, starting of image capturing, stopping of image capturing, so on. The input I/F 206 is a communication interface employing a serial bus complying with Serial Digital Interface (SDI), High-Definition Multimedia Interface (registered trademark) (HDMI (registered trademark)), or the like. Captured image data output from each image capturing apparatus 101 is obtained via the input I/F 206. The output I/F 207 is a communication interface employing a serial bus complying Universal Serial Bus (USB), DisplayPort (registered trademark), or the like. Data or image signals of virtual viewpoint images and the like are output via the output I/F 207 to the storage apparatus 104 or the display apparatus 105. The main bus 208 is a transfer channel by which the above-described hardware components of the image processing apparatus 102 are communicatively connected to one another.

### <Functional Configuration of Image Processing Apparatus>

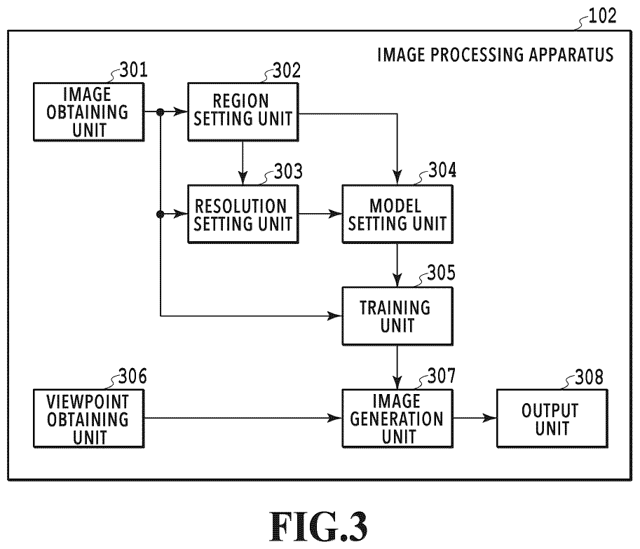

FIG. 3 is a block diagram illustrating an example of a functional configuration of the image processing apparatus 102 according to the first embodiment. The image processing apparatus 102 has an image obtaining unit 301, a region setting unit 302, a resolution setting unit 303, a model setting unit 304, a training unit 305, a viewpoint obtaining unit 306, an image generation unit 307, and an output unit 308. The units included in the image processing apparatus 102 as its functional components are each implemented by causing the CPU 201 to execute a program stored in the ROM 203 or the like with the RAM 202 as a work memory. Note that not all of the below-described processes by the units included in the image processing apparatus 102 as its functional components necessarily need to be implemented by causing the CPU 201 to execute a program, and the configuration may be such that some or all of the processes are executed by one or more processing circuits other than the CPU 201.

The image obtaining unit 301 obtains captured image data obtained by capturing images of the image capturing region 106 with the image capturing apparatuses 101 and parameters of the image capturing apparatuses 101 for the capturing of the captured images (hereinafter referred to as “image capturing parameters”). The region setting unit 302 sets a space including the object 107 in the image capturing region 106 as a partial region based on the captured image data and image capturing parameters obtained by the image obtaining unit 301. The resolution setting unit 303 sets a pixel resolution for the partial region set by the region setting unit 302 based on the image capturing parameters obtained by the image obtaining unit 301 and the partial region. The model setting unit 304 sets a learning model corresponding to the partial region set by the region setting unit 302 based on the partial region, the pixel resolution for the partial region set by the resolution setting unit 303.

The training unit 305 performs training on information on a radiance field of the space including the object 107 (three-dimensional information) based on the captured image data and image capturing parameters obtained by the image obtaining unit 301 and the learning model set by the model setting unit 304. Here, the three-dimensional information is network parameters in a learning model constructed by multi-layer perceptrons (MLPs) which represent the radiance field of the space including the object 107, for example.

The viewpoint obtaining unit 306 obtains information on a virtual viewpoint (hereinafter referred to as “virtual viewpoint information”). Here, the virtual viewpoint information is information which indicates the position of the virtual viewpoint and the line-of-sight direction from the virtual viewpoint, and corresponds to image capturing parameters of an imaginary image capturing apparatus placed at the virtual viewpoint (hereinafter referred to as “virtual camera”) (these image capturing parameters will hereinafter be referred to as “virtual camera parameters”). The image generation unit 307 generates a virtual viewpoint image by using learned three-dimensional information obtained as a result of the training by the training unit 305, i.e., a learned model representing information on the radiance field and the virtual camera parameters obtained by the viewpoint obtaining unit 306. Specifically, the image generation unit 307 generates a virtual viewpoint image corresponding to a view from the virtual viewpoint indicated by the virtual camera parameters by performing volume rendering using the learned three-dimensional information.

The output unit 308 outputs data of the virtual viewpoint image generated by the image generation unit 307 to the storage apparatus 104 to store the data in the storage apparatus 104. The output unit 308 may output the virtual viewpoint image in the form of image signals to the display apparatus 105 to display the virtual viewpoint image on the display apparatus 105. Also, the output unit 308 outputs the learned three-dimensional information obtained as a result of the training by the training unit 305, i.e., the learned model being information on the radiance field, to the storage apparatus 104 or the like.

### <Operation of Image Processing Apparatus>

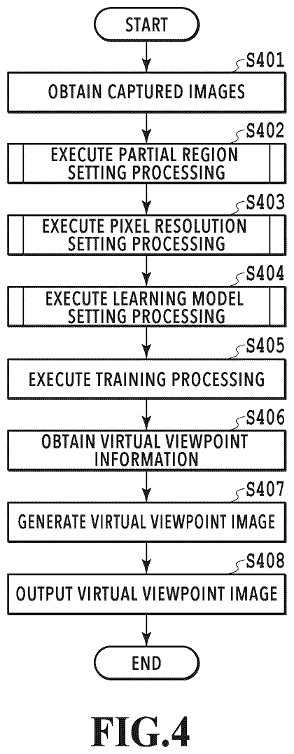

FIG. 4 is a flowchart illustrating an example of a flow of processing by the image processing apparatus 102 according to the first embodiment. In the following, each processing step (process) will be denoted by a reference number prefixed with “S.” In a case where each image capturing apparatus 101 outputs data of a moving image as captured image data, the image processing apparatus 102 executes the processing of the flowchart each time the image capturing apparatus 101 outputs data of a frame included in the moving image obtained by synchronized image capturing. First, in S401, the image obtaining unit 301 obtains a plurality of pieces of captured image data obtained by the image capturing and the image capturing parameters of the pieces of captured image data. Specifically, for example, each piece of captured image data is obtained from the corresponding image capturing apparatus 101 via the input I/F 206, and the image capturing parameters are obtained by reading out parameters that were calculated by executing calibration or the like and stored in the storage device 204 in advance. The pieces of captured image data and image capturing parameters obtained in S401 are then held in the RAM 202.

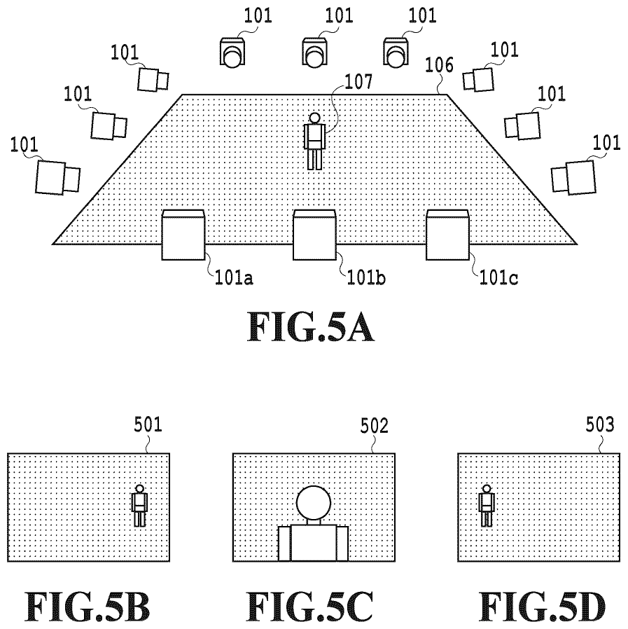

FIG. 5A is a diagram illustrating an example of a layout of the image capturing apparatuses 101 according to the first embodiment, and FIGS. 5B to 5D are diagrams illustrating an example of captured images 501 to 503 obtained by image capturing by image capturing apparatuses 101a to 101c. The plurality of image capturing apparatuses 101 are placed so as to be able to capture images of the object 107 present in the image capturing region 106 from various directions. Note that the present embodiment will be described on the assumption that the focal lengths of the optical systems of the image capturing apparatuses 101a and 101c illustrated in FIG. 5A are short as with the other image capturing apparatuses 101 while the focal length of the optical system of the image capturing apparatus 101b is longer than those of the other image capturing apparatuses 101. That is, the image capturing apparatus 101b is capable of capturing images of the object 107 at a higher resolution than the image capturing apparatuses 101a and 101c. FIG. 5B illustrates an example of the captured image 501 obtained by image capturing by the image capturing apparatus 101a, FIG. 5C illustrates an example of the captured image 502 obtained by image capturing by the image capturing apparatus 101b, and FIG. 5D illustrates an example of the captured image 503 obtained by image capturing by the image capturing apparatus 101c.

S401 is followed by S402, in which the region setting unit 302 sets a space including the object 107 as a partial region based on the pieces of captured image data and image capturing parameters obtained in S401. Details of the partial region setting processing by the region setting unit 302 will be described later. Then, in S403, based on the image capturing parameters obtained in S401 and the partial region set in S402, the resolution setting unit 303 sets a pixel resolution for the partial region by executing pixel resolution setting processing. Specifically, for example, the resolution setting unit 303 sets the highest pixel resolution among the pixel resolutions of the image capturing apparatuses 101 at a reference point inside the partial region as the pixel resolution for the partial region. Details of the pixel resolution setting processing by the resolution setting unit 303 will be described later. Then, in S404, based on the partial region set in S402 and the pixel resolution for the partial region set in S403, the model setting unit 304 sets a learning model corresponding to the partial region by executing learning model setting processing. Details of the learning model setting processing by the model setting unit 304 will be described later.

Then, in S405, the training unit 305 executes three-dimensional information training processing. Specifically, the training unit 305 trains the learning model, which represents a radiance field of the space including the object 107, based on the pieces of captured image data and image capturing parameters obtained in S401 and the learning model set in S404. The present embodiment will be exemplarily described on the assumption that the radiance field is a function which receives information indicating an encoded position and direction within the image capturing region 106 and outputs information indicating a density and color, is represented by a learning model implementing this function with MLPs. Specifically, the MLPs according to the present embodiment are configured to receive information indicating an encoded position and direction within the image capturing region 106 which is input into the input layer and, based on the information, calculate information indicating a color and density according to inter-node connection weights and output the result of the calculation from the output layer.

The training of the learning model representing the radiance field is performed based on the differences between the values of pixels obtained by volume rendering using the image capturing parameters and the radiance field (hereinafter referred to as “rendering values”) and the values of pixels in captured images corresponding to the above pixels (pixel values). Specifically, the training unit 305 trains the learning model representing the radiance field by updating the values of the connection weights in the MLPs representing the radiance field so as to reduce the differences between the above pixel values.

For example, first, the training unit 305 obtains ray information on each pixel in each captured image based on the image capturing parameters. Each piece of ray information includes information indicating the start point, direction, and color of a ray. Here, the color of a ray means the value of the pixel (pixel value) in the captured image corresponding to the ray. Subsequently, with each piece of ray information, the training unit 305 sets a plurality of sampling points on the corresponding ray, and obtains information indicating densities and colors corresponding to the positions of the sampling points and the direction of the ray based on the MLPs representing the radiance field to calculate a rendering value corresponding to the ray. Specifically, the training unit 305 calculates the rendering value corresponding to each ray by using Equations (1) and (2), for example.

$$C ( r ) = {\sum }_{i = 1}^{N} {T}_{i} ( 1 - exp ( - {σ}_{i} {δ}_{i} ) ) {c}_{i} \qquad Equation ( 1 )$$

$${T}_{i} = exp ( - {\sum }_{j = 1}^{i - 1} - {σ}_{j} {δ}_{j} ) \qquad Equation ( 2 )$$

Here, C(r) is the rendering value corresponding to a ray r, i is an index for a sampling point, σᵢ is the density at the sampling point, cᵢ is the color at the sampling point, and δᵢ is the distance to the next sampling point. Note that Tᵢ denotes the cumulative transmittance at the sampling point. The training unit 305 updates the values of connection weights in the MLPs so as to make small the squared Euclidean distance between the rendering value C(r) corresponding to the ray and the color of the ray, i.e., the value of the pixel in the captured image corresponding to the ray (pixel value). The process of S405 is equivalent to the error calculation processing and error propagation processing in deep learning.

S405 is followed by S406, in which the viewpoint obtaining unit 306 obtains virtual camera parameters set based on an instruction from the user via the UI panel 103 as virtual viewpoint information. The method by which the viewpoint obtaining unit 306 obtains virtual camera parameters is not limited to the above method. For example, the viewpoint obtaining unit 306 may read out virtual camera parameters stored in the storage device 204 or the like in advance to obtain the virtual camera parameters.

Then, in S407, the image generation unit 307 generates a virtual viewpoint image by using the virtual camera parameters obtained in S406 and the learned three-dimensional information obtained as a result of the training processing in S405, i.e., a learned model representing the radiance field. Specifically, the image generation unit 307 generates a virtual viewpoint image corresponding to a view from the virtual viewpoint indicated by the virtual camera parameters by performing volume rendering based on the virtual camera parameters for the learned three-dimensional information that is the learned model representing the radiance field.

Then, in S408, the output unit 308 outputs the virtual viewpoint image generated in S407. Specifically, for example, the output unit 308 outputs data of the virtual viewpoint image or image signals representing the virtual viewpoint image to the storage apparatus 104, the display apparatus 105, or the like via the output I/F 207. After S408, the image processing apparatus 102 terminates the processing of the flowchart illustrated in FIG. 4. Note that, as described above, in a case where each image capturing apparatus 101 outputs data of a moving image as captured image data, the image processing apparatus 102 returns to S401 after S408 and repeats the processing of the flowchart.

### <Partial Region Setting Processing>

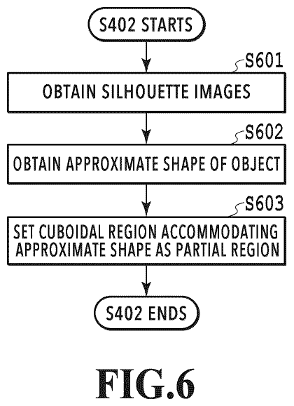

FIG. 6 is a flowchart illustrating an example of a flow of the partial region setting processing by the region setting unit 302 according to the first embodiment, and is a flowchart illustrating an example of a detailed flow of the processing in S402 illustrated in FIG. 4. In S402, a space including the object 107 is set as a partial region based on the pieces of captured image data and image capturing parameters obtained in S401. The present embodiment will exemplarily describe a mode in which the region setting unit 302 obtains an approximate shape of the object represented as a set of voxels by using Visual Hull and sets a cuboidal region accommodating the approximate shape of the object as the partial region.

S401 is followed firstly by S601, in which the region setting unit 302 obtains silhouette images corresponding to the respective pieces of captured image data obtained in S401. Here, each silhouette image is an image indicating a region including a representation of the object 107 in the captured image. Specifically, first, the region setting unit 302 obtains data of a background image (hereinafter referred to as “background image data”) obtained by capturing an image of only a background without the object 107 with each image capturing apparatus 101. The region setting unit 302 may obtain the background image data by, for example, reading out background image data captured in advance by each image capturing apparatus 101 and stored in the storage device 204 or the like in advance. Subsequently, the region setting unit 302 obtains silhouette images of the object 107 based on the differences between the pieces of captured image data corresponding to the image capturing apparatuses 101 and the pieces of background image data corresponding to the pieces of captured image data. The method of obtaining the silhouette images of the object 107 is publicly known, and detailed description thereof is therefore omitted.

Then, in S602, the region setting unit 302 obtains an approximate shape of the object 107 based on the image capturing parameters obtained in S401 and the silhouette images obtained in S601. Specifically, for example, the region setting unit 302 firstly projects voxels included in a set of voxels corresponding to the image capturing region 106 to the silhouette images based on the image capturing parameters obtained in S401. Subsequently, the region setting unit 302 obtains the set of voxels projected to the silhouette regions corresponding to the regions of the representations of the object 107 in all silhouette images as an approximate shape of the object. The method of obtaining the approximate shape of the object 107 by using Visual Hull with silhouette images or the like is publicly known, and detailed description thereof is therefore omitted. Also, the method of obtaining the approximate shape of the object 107 is not limited to Visual Hull, and may be any method.

Then, in S603, the region setting unit 302 sets a cuboidal region accommodating the approximate shape of the object 107 obtained in S602 as a partial region. The region setting unit 302 may set a cuboidal region with a predetermined margin set between itself and the approximate shape of the object as the partial region, or set a margin-less cuboidal region externally tangent to the approximate shape of the object as the partial region. After S603, the region setting unit 302 terminates the processing of the flowchart illustrated in FIG. 6, i.e., the process of S402 illustrated in FIG. 4.

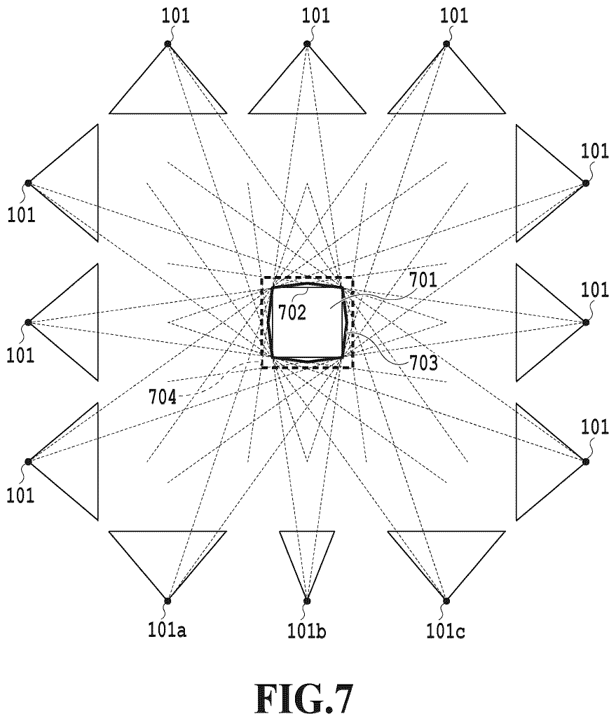

FIG. 7 is a diagram illustrating an example of the partial region set by the region setting unit 302 according to the first embodiment. In FIG. 7, the rectangle surrounded by a narrow solid line indicates an actual outline 702 of an object 701, and the polygon surrounded by a thick solid line indicates an outline of an approximate shape 703 of the object 701. Also, the polygon surrounded by a thick dashed line indicates an outline of a partial region 704 set by the region setting unit 302.

### <Pixel Resolution Setting Processing>

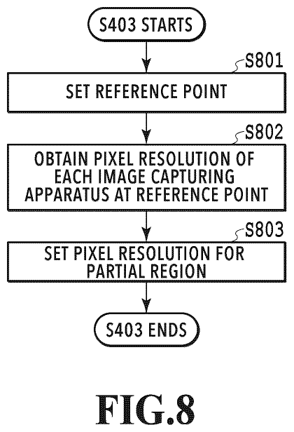

FIG. 8 is a flowchart illustrating an example of a flow of the pixel resolution setting processing by the resolution setting unit 303 according to the first embodiment, and is a flowchart illustrating an example of a detailed flow of the processing in S403 illustrated in FIG. 4. In S403, based on the image capturing parameters obtained in S401 and the partial region set in S402, a pixel resolution for the partial region is set.

S402 is followed firstly by S801, in which the resolution setting unit 303 sets a reference point in the partial region set in S402. The present embodiment will be exemplarily described on the assumption that the resolution setting unit 303 sets the position of the center in the partial region as the reference point, but the reference point may be any position inside the partial region, such as the center of gravity of the partial region. Then, in S802, the resolution setting unit 303 calculates the pixel resolutions of image capturing apparatuses 101 at the reference point set in S601 by using the image capturing parameters obtained in S401. First, the resolution setting unit 303 specifies the image capturing apparatuses 101 having the reference point within their angles of view. For example, the resolution setting unit 303 judges that an image capturing apparatus 101 has the reference point within its angle of view in a case where the captured image includes the reference point projected using the image capturing parameters. Subsequently, for each image capturing apparatus 101 having the reference point within its angle of view, the resolution setting unit 303 calculates the pixel resolution of the image capturing apparatus 101 at the reference point by using Equation (3), for example.

$${r}_{ij} = {d}_{ij} / {f}_{j} \qquad Equation ( 3 )$$

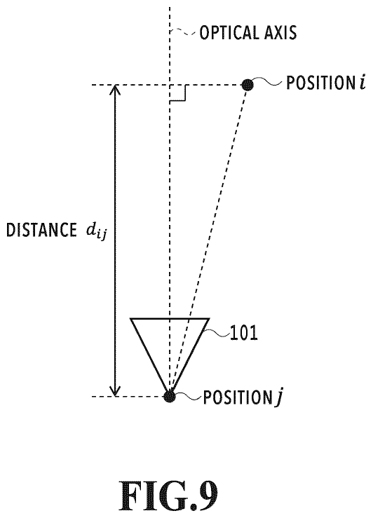

Here, rᵢⱼ is a value indicating the pixel resolution of the image capturing apparatus 101 at a position i of the reference point (hereinafter referred to as “resolution value”); and dᵢⱼ is the distance from a position j of the image capturing apparatus 101 to the position i of the reference point in the depth direction along the optical axis of the image capturing apparatus 101 (hereinafter referred to as “reference point distance”). FIG. 9 is a diagram for describing an example of the reference point distance dᵢⱼ according to the first embodiment. Here, fⱼ is a value obtained by multiplying the number of light-sensitive elements per unit length in the image sensor of the image capturing apparatus 101 disposed at the position j by the focal length of the optical system of the image capturing apparatus 101, and is considered a value indicating the focal length as an intrinsic parameter of the image capturing apparatus 101.

The resolution value rᵢⱼ is a value indicating a length per light receiving pixel of the image capturing apparatus 101 at the reference point. Hence, the smaller the resolution value rᵢⱼ, the higher the pixel resolution of the image capturing apparatus 101 at the reference point. Also, the smaller the value of the reference point distance dᵢⱼ, that is, the smaller the value of the distance from the position j of the image capturing apparatus 101 to the position i of the reference point, the smaller the resolution value rᵢⱼ and therefore the higher the pixel resolution. Also, the larger the value of fⱼ, that is, the longer the focal length of the image capturing apparatus 101, the smaller the resolution value rᵢⱼ and therefore the higher the pixel resolution. For example, in a case where the distances in the depth direction from the position of the reference point to the positions of the image capturing apparatuses 101a, 101b, and 101c are equal to one another, the image capturing apparatus 101b, which has a long focal length, has a higher pixel resolution at the reference point than the pixel resolutions at the reference point of the image capturing apparatuses 101a and 101c, which have a short focal length(s). Also, in a case where the focal lengths of the image capturing apparatuses 101a, 101b, and 101c are equal to one another, an image capturing apparatus 101, among the image capturing apparatuses 101a, 101b, and 101c, that has a smaller value of the distance in the depth direction from the position of the image capturing apparatus 101 to the position of the reference point has a higher pixel resolution at the reference point.

S802 is followed by S803, in which the resolution setting unit 303 sets a pixel resolution for the partial region based on the pixel resolutions of the image capturing apparatuses 101 at the reference point. For example, the resolution setting unit 303 selects the highest pixel resolution among the pixel resolutions of the image capturing apparatuses 101 at the reference point and sets the selected pixel resolution as the pixel resolution for the partial region. Specifically, for example, the resolution setting unit 303 selects the smallest value among the values indicating the pixel resolutions of the image capturing apparatuses 101 at the reference point (resolution values rᵢⱼ) as the resolution value for the partial region by using Equation (4).

$${r}_{i} = {min}_{j} ( {r}_{ij} ) \qquad Equation ( 4 )$$

Here, rᵢ is the resolution value for the partial region. After S803, the resolution setting unit 303 terminates the processing of the flowchart illustrated in FIG. 8, i.e., the process of S403 illustrated in FIG. 4. As a result of this processing, the resolution setting unit 303 sets a single resolution value rᵢ for the partial region.

### <Learning Model Setting Processing>

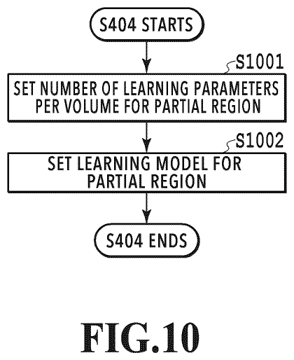

FIG. 10 is a flowchart illustrating an example of a flow of the learning model setting processing by the model setting unit 304 according to the first embodiment, and is a flowchart illustrating an example of a detailed flow of the processing in S404 illustrated in FIG. 4. In S404, a learning model corresponding to the partial region is set based on the partial region set in S402 and the pixel resolution for the partial region set in S403. Note that the present embodiment will exemplarily describe a mode in which the model setting unit 304 performs processing for setting the learning model corresponding to the partial region by controlling the total number of layers in the intermediate layer of an MLP constructing the learning model based on the partial region. Specifically, the present embodiment will be described on the assumption that the learning model is constructed by an MLP that presents densities (hereinafter referred to as “density MLP”) and an MLP that presents colors, and the model setting unit 304 controls the number of layers in the intermediate layer in the density MLP.

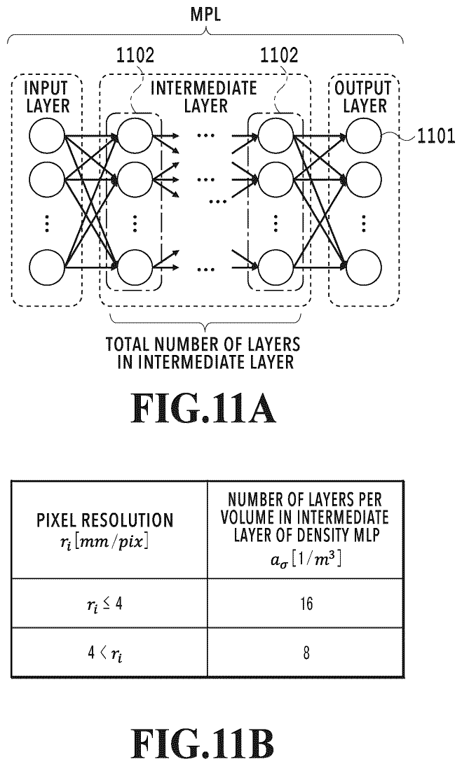

FIGS. 11A and 11B are diagrams for describing an example of the learning model setting processing by the model setting unit 304 according to the first embodiment. FIG. 11A illustrates an example of an MLP. The MLP includes an input layer with one or more nodes 1101, an intermediate layer having one or more layers 1102 with one or more nodes 1101, and an output layer with one or more nodes 1101.

S403 is followed firstly by S1001, in which the model setting unit 304 sets the learning parameter count per volume in the learning model corresponding to the partial region based on the pixel resolution for the partial region set in $403. Specifically, for example, the model setting unit 304 sets the learning parameter count per volume such that the higher the pixel resolution for the partial region, that is, the smaller the resolution value rᵢ, the larger the number of layers per volume in the intermediate layer of the density MLP corresponding to the partial region. For example, the model setting unit 304 refers to a lookup table in which pixel resolutions and numbers of layers per volume in the intermediate layer of the density MLP have been associated with each other in advance. Using this lookup table, the model setting unit 304 determines the number of layers per volume in the intermediate layer of the density MLP corresponding to the partial region according to the pixel resolution for the partial region.

For example, partial regions whose resolution values rᵢ are less than or equal to a predetermined value are defined as partial regions with high pixel resolutions in advance, and partial regions whose resolution values rᵢ are more than the predetermined value are defined as partial regions with low pixel resolutions in advance. Specifically, as in the lookup table exemplarily illustrated in FIG. 11B, for example, partial regions whose resolution values rᵢ are less than or equal to 4 mm (millimeters)/pix (pixel) are defined as partial regions with high pixel resolutions in advance. Also, partial regions whose resolution values rᵢ are more than 4 mm/pix are defined as partial regions with low pixel resolutions in advance. The model setting unit 304 sets a large value, such as 16, as the number of layers per volume in the intermediate layer of the density MLP for partial regions whose resolution values rᵢ are less than or equal to 4 mm/pix, that is, whose pixel resolutions are high. Also, the model setting unit 304 sets a small value, such as 8, as the number of layers per volume in the intermediate layer of the density MLP for partial regions whose resolution values rᵢ are more than 4 mm/pix, that is, whose pixel resolutions are low. As described above, the model setting unit 304, for example, determines one of two values as the number of layers per volume in the intermediate layer of the density MLP corresponding to the partial region according to the pixel resolution for the partial region.

S1001 is followed by S1002, in which the model setting unit 304 sets the learning model for which the learning parameter count per volume has been set in S1001 for the partial region set in S402. The present embodiment will be described on the assumption that the cuboidal region set as the partial region is a region to which to assign the learning model (hereinafter referred to as “learning region”). Specifically, the model setting unit 304 sets a value obtained by converting the product of the number of layers per volume in the intermediate layer of the density MLP set in S1001 and the volume of the learning region into an integer as the total number of layers in the intermediate layer of the density MLP constructing the learning model. After S1002, the model setting unit 304 terminates the processing of the flowchart illustrated in FIG. 10, i.e., the process of S404 illustrated in FIG. 4. As a result of the process of S404, a learning model constructed by a density MLP with a large number of layers per volume in the intermediate layer is set for the partial region in a case where its pixel resolution is high. A learning model constructed by a density MLP with a small number of layers per volume in the intermediate layer is set for the partial region in a case where its pixel resolution is low.

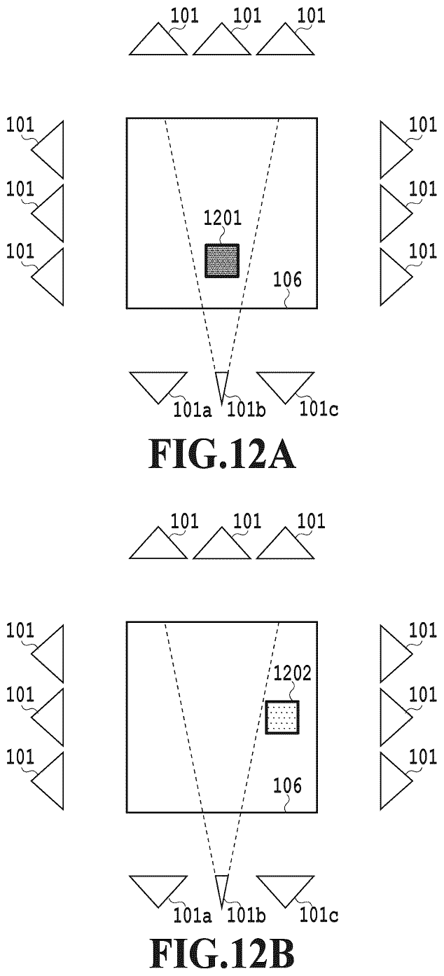

FIGS. 12A and 12B are diagrams illustrating an example of partial regions 1201 and 1202 according to the first embodiment. For example, the partial region 1201, which is situated within the angle of view of the image capturing apparatus 101b with a long focal length, as illustrated in FIG. 12A, has a high pixel resolution. For this reason, a learning model constructed by a density MLP with a large number of layers per volume in the intermediate layer is set. On the other hand, the partial region 1202, which is situated within the angle of view of only an image capturing apparatus 101 with a short focal length, as illustrated in FIG. 12B, has a low pixel resolution. For this reason, a learning model constructed by a density MLP with a small number of layers per volume in the intermediate layer is set. That the learning parameter count per volume is large for the partial region 1201 with a high pixel resolution allows for accurate estimation of the radiance field, i.e., three-dimensional information. Also, that the learning parameter count per volume is small for the partial region 1202 with a low pixel resolution allows for a reduction in the amount of computation required to estimate the three-dimensional information and in the amount of information in the three-dimensional information.

### <Advantageous Effect Provided by Image Processing Apparatus>

As described above, the image processing apparatus 102 performs training on three-dimensional information on a space including the object 107 based on a plurality of pieces of captured image data obtained by capturing images of the object 107 from various directions with the plurality of image capturing apparatuses 101. In particular, in the present embodiment, the image processing apparatus 102 is configured to obtain a pixel resolution for a partial region based on image capturing parameters and set a learning model with a large learning parameter count per volume for the partial region in a case where the pixel resolution is high. The image processing apparatus 102 is configured to conversely set a learning model with a small learning parameter count per volume for the partial region in a case where the pixel resolution is low. The image processing apparatus 102 thus configured can estimate accurate three-dimensional information while reducing the amount of computation required to estimate the three-dimensional information and the amount of information in the three-dimensional information. In particular, the image processing apparatus 102 can accurately estimate three-dimensional information of a space where an image capturing apparatus 101 has a high pixel resolution. This improves the image quality of virtual viewpoint images generated based on the estimated three-dimensional information.

### Modifications of First Embodiment

In the first embodiment, it has been described that the image capturing apparatus 101b is the only image capturing apparatus 101 with a long focal length, but the configuration of the image capturing apparatuses 101 is not limited to this. For example, the focal lengths of all image capturing apparatuses 101 may be equal, there may be a plurality of image capturing apparatuses 101 with a longer focal length(s) than those of the other image capturing apparatuses 101, or the focal lengths of all image capturing apparatuses 101 may be different.

Also, it has been described that the region setting unit 302 according to the first embodiment obtains an approximate shape of the object 107 by using Visual Hull in the process of S402, but the method of obtaining an approximate shape of the object 107 is not limited to this. For example, the region setting unit 302 may obtain an approximate shape of the object 107 based on distance information obtained by stereo matching or the like using pieces of captured image data obtained by the image obtaining unit 301 or on distance images obtained by depth cameras. Also, information representing an approximate shape of the object 107 generated in advance may be stored in the storage device 204 or the like, and the region setting unit 302 may read out this information to obtain the approximate shape of the object 107.

Also, it has been described that the region setting unit 302 according to the first embodiment sets a partial region for a single object 107 in the process of S402, but a partial region may be set for each of a plurality of objects. For example, in a case where a plurality of objects out of contact with each other are present within an image capturing region, then in S602, the region setting unit 302 obtains a plurality of sets of voxels corresponding to the respective objects by using Visual Hull as a plurality of approximate shapes. Subsequently, in S603, for each of the plurality of approximate shapes obtained in S602, the region setting unit 302 sets a cuboidal region accommodating the approximate shape as a partial region.

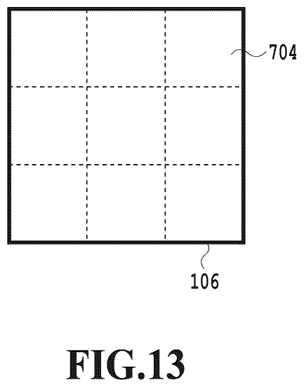

Also, it has been described that the region setting unit 302 according to the first embodiment sets a single cuboidal shape accommodating an approximate shape of the object 107 as a partial region in the process of S402, but the method of setting a partial region is not limited to this. For example, the region setting unit 302 may set each of a plurality of regions obtained by dividing the image capturing region as a partial region. FIG. 13 is a diagram illustrating an example of partial regions 1301 according to a modification of the first embodiment. Note that FIG. 13 is a diagram of the image capturing region 106 as viewed from the vertical direction. For example, as illustrated in FIG. 13, the region setting unit 302 may set each of the nine regions obtained by dividing the image capturing region 106 along the vertical direction as a partial region 704 in the process of S402.

Also, it has been described that the resolution setting unit 303 according to the first embodiment sets the center of the partial region as a reference point in the process of S801, but the center of gravity of the approximate shape of the object 107 may be set as the reference point. For example, the resolution setting unit 303 calculates the center of gravity of the approximate shape of the object 107 based on the set of voxels forming the approximate shape of the object 107, and sets this center of gravity as the reference point in the partial region.

Also, it has been described that the resolution setting unit 303 according to the first embodiment specifies the image capturing apparatuses 101 which have the reference point within their angles of view in the process of S802, but the resolution setting unit 303 may specify the image capturing apparatuses 101 which have the reference point within their angles of view and from which the reference point is not occluded. Here, the resolution setting unit 303 judges that the reference point is not occluded, for example, in a case where other partial regions not including the reference point or approximate shapes of other objects are not present between the reference point and the image capturing apparatus 101.

Also, it has been described that the resolution setting unit 303 according to the first embodiment sets the pixel resolution at the reference point based on the image capturing parameters in the process of S403, but the resolution setting unit 303 may set the pixel resolution according only to the position of the reference position. For example, the resolution setting unit 303 sets a pixel resolution for each of a plurality of regions obtained by dividing the image capturing region 106 in advance, and sets the pixel resolution of the region including the reference point as the pixel resolution for the reference point.

Also, it has been described that the model setting unit 304 according to the first embodiment controls the total number of layers in the intermediate layer of the MLP in the process of S404, but the model setting unit 304 may control the number of nodes per layer in the intermediate layer of the MLP. For example, the model setting unit 304 sets a learning model such that the higher the pixel resolution, the larger the number of nodes per layer in the intermediate layer of the MLP.

Also, it has been described that the model setting unit 304 according to the first embodiment sets a learning model based on the learning parameter count per volume in the process of S404, but the method of setting a learning model is not limited to this. For example, the model setting unit 304 may set the learning parameter count per MLP to a predetermined number and set a learning model to the partial region such that the higher the pixel resolution, the smaller the learning region. Also, the model setting unit 304 may, for example, set the size of the learning region to a predetermined size and set a learning model to the partial region such that the higher the pixel resolution, the larger the learning parameter count per MLP. In this case, the model setting unit 304 sets one or more learning models such that the learning region includes the entire partial region.

Also, the model setting unit 304 according to the first embodiment sets a learning model constructed by an MLP in the process of S404, but the configuration of the learning model is not limited to this. For example, the model setting unit 304 may set a learning model constructed by a plurality of learning parameters arranged at a predetermined interval in a grid pattern within a three-dimensional space. Specifically, the model setting unit 304 may use a learning model that represents a radiance field of a space based on a plurality of spherical harmonics arranged in a grid pattern. The learning model to be used by the model setting unit 304 is not limited to this.

For example, the model setting unit 304 may use a learning model that represents a radiance field of a space based on a matrix with a predetermined number of components having an element for each grid or a set of vectors, or the like. In this case, the model setting unit 304 sets a learning model such that the higher the pixel resolution, the larger the number of grids per volume, that is, the smaller the grid intervals. The model setting unit 304 may set a learning model such that the higher the pixel resolution, the larger the learning parameter count per grid. Here, the learning parameter count per grid is equivalent to the number of coefficients in spherical harmonics or the number of components.

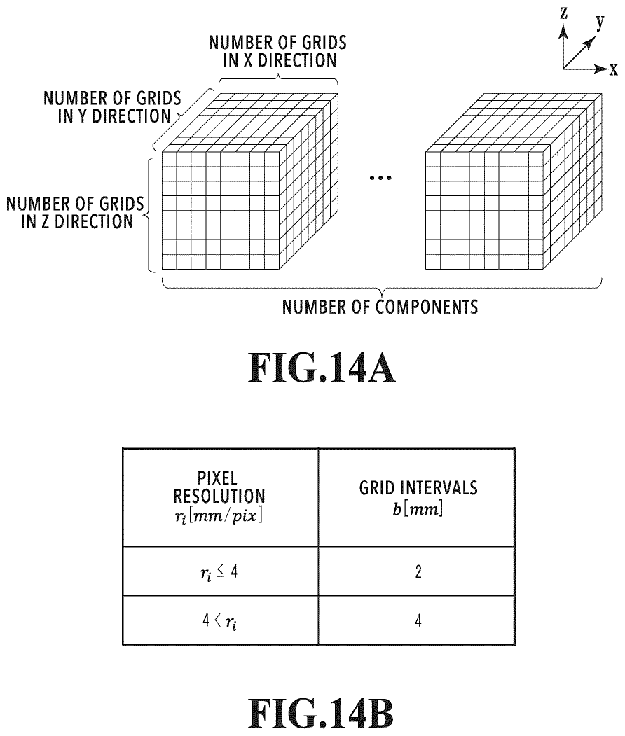

FIGS. 14A and 14B are diagrams for describing an example of the learning model setting processing by the model setting unit 304 according to a modification of the first embodiment. FIG. 14A is a diagram illustrating an example of grids and components according to a modification of the first embodiment. For example, the model setting unit 304 sets a learning model such that the smaller the resolution value rᵢ, the smaller the grid intervals, and associates the learning model with the partial region. Specifically, as in the lookup table exemplarily illustrated in FIG. 14B, for example, resolution values rᵢ and grid intervals are defined in association with each other in advance. Using this lookup table, the model setting unit 304 determines the grid intervals based on the resolution value rᵢ. Then, based on values each obtained by dividing the length of the learning region in the direction of an axis by the grid intervals, the model setting unit 304 determines the numbers of grids and sets a learning model.

Also, it has been described that the model setting unit 304 according to the first embodiment sets a cuboidal region set as a partial region as a learning region in the process of S1002. Alternatively, the model setting unit 304 may set one or more learning regions as described below based on the number of layers per volume in the intermediate layer of the MLP. Specifically, with the product of the number of layers per volume in the intermediate layer of the MLP and the volume of the partial region, the model setting unit 304 calculates the total number of layers in the intermediate layer of the MLP corresponding to the partial region. In a case where the calculated total number of layers in the intermediate layer of the MLP corresponding to the partial region is more than a predetermined value, the model setting unit 304, for example, sets each of a plurality of regions obtained by dividing the partial region as a learning region. Specifically, for example, in this case, the model setting unit 304 divides the partial region into a plurality of regions such that the total number of layers in the intermediate layer of the MLP corresponding to each of the regions obtained by dividing the partial region is less than or equal to a predetermined value. Also, for example, the model setting unit 304 sets a region obtained by integrating a plurality of partial regions as a learning region in a case where the total number of layers in the intermediate layer of the MLP corresponding to each partial region is less than a predetermined value. Specifically, for example, in this case, the model setting unit 304 integrates a plurality of neighboring partial regions such that the total number of layers in the intermediate layer of the MLP corresponding to the region obtained by integrating the plurality of partial regions do not exceed a predetermined value.

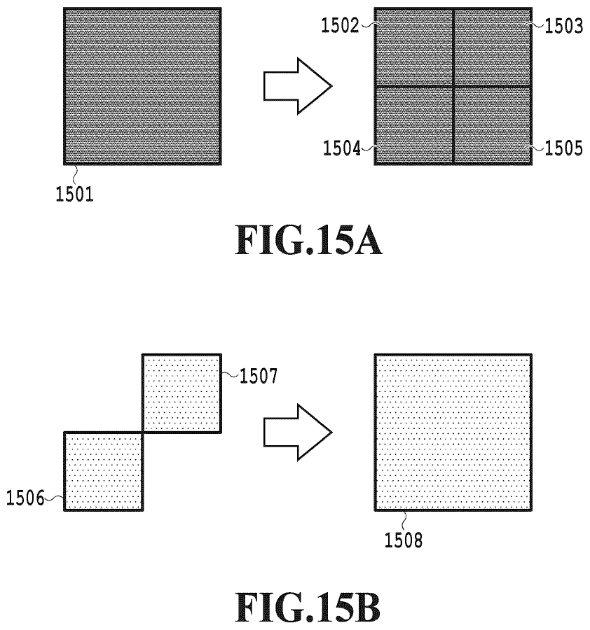

FIGS. 15A and 15B are diagrams illustrating an example of the division of a partial region and the integration of partial regions according to a modification of the first embodiment. For example, as illustrated in FIG. 15A, the model setting unit 304 divides a partial region 1501 for which the total number of layers in the intermediate layer of the MLP is more than a predetermined value into four regions 1502 to 1505, and sets each of the divided regions 1502 to 1505 as a partial region. Also, for example, as illustrated in FIG. 15B, the model setting unit 304 integrates partial regions 1506 and 1507 for which the total number of layers in the intermediate layer of the MLP is less than a predetermined value into a single partial region 1508.

Also, it has been described that, in the process of S1002, the model setting unit 304 according to the first embodiment selects and determines one of two values as the number of layers per volume in the intermediate layer of the density MLP corresponding to the partial region. Alternatively, the model setting unit 304 may select and determine one of three or more values.

Also, it has been described that the image processing apparatus 102 according to the first embodiment trains a learning model that represents a radiance field, but the learning model to be trained is not limited to a model that represents a radiance field. The learning model only needs to be a model that represents three-dimensional information that may be subjected to training based on captured image data. For example, while a radiance field presents colors and densities corresponding to positions and directions, the three-dimensional information is not limited to such a thing. Specifically, for example, the three-dimensional information may be information indicating colors at positions within the space in the three-dimensional information in the form of isotropic colors that are not direction-dependent. Also, for example, the three-dimensional information may be information indicating densities at positions within the space in the three-dimensional information in the form of signed distance fields representing distances to object surfaces corresponding to the positions. Also, the three-dimensional information may be information representing a density field which indicates densities at positions, a field represented by the bidirectional reflectance distribution function, which indicates distribution characteristics of reflected light with respect to incident light, a field which represents the penetration amount of ambient light (light visibility), or the like, for example. Also, the three-dimensional information may be information representing a field which indicates color and densities corresponding to positions, directions, and times. In this case, the pieces of captured image data to be used in the training of the three-dimensional information are data of moving images including a chronological series of frames.

### Second Embodiment

An image processing apparatus 102 according to a second embodiment (hereinafter referred to simply as “the image processing apparatus 102”) will now be described with reference to FIGS. 2 to 4 and FIGS. 16 to 19D. The image processing apparatus 102 has a hardware configuration and functional configuration as exemplarily illustrated in the block diagrams of FIGS. 2 and 3, like the image processing apparatus 102 according to the first embodiment. Also, the image processing apparatus 102 executes the processing of the flowchart exemplarily illustrated in FIG. 4, like the image processing apparatus 102 according to the first embodiment. In the present embodiment, however, the processing by the resolution setting unit 303 and the model setting unit 304 differ from the processing by the resolution setting unit 303 and the model setting unit 304 according to the first embodiment. Specifically, the pixel resolution setting processing in S403 and the learning model setting in S404 according to the present embodiment differ from the processing in S403 and the processing in S404 according to the first embodiment.

Specifically, in the pixel resolution setting processing in S403, the resolution setting unit 303 according to the first embodiment sets the highest pixel resolution among the pixel resolutions of the image capturing apparatuses 101 at the reference point within the partial region as the pixel resolution for the partial region. The resolution setting unit 303 according to the present embodiment, on the other hand, sets a plurality of direction-specific pixel resolutions as pixel resolutions for the partial region based on the pixel resolutions of the image capturing apparatuses 101 at the reference point within the partial region. Also, the model setting unit 304 according to the present embodiment sets a learning model for the partial region based on the plurality of direction-specific pixel resolutions set by the resolution setting unit 303.

In the following, the present embodiment will mainly describe the pixel resolution setting processing by the resolution setting unit 303 and the learning model setting processing by the model setting unit 304 involving different processes than those in the first embodiment. Note that the components or process steps that perform or involve the same processes as those in the first embodiment will be denoted by the same reference signs, and description thereof will be omitted.

### <Pixel Resolution Setting Processing>

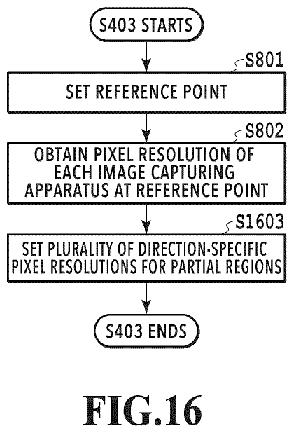

FIG. 16 is a flowchart illustrating an example of a flow of the pixel resolution setting processing by the resolution setting unit 303 according to the second embodiment, and is a flowchart illustrating an example of a detailed flow of the processing in S403 illustrated in FIG. 4. S403 according to the second embodiment involves setting a plurality of direction-specific pixel resolutions as pixel resolutions for the partial region based on the pixel resolutions of the image capturing apparatuses 101 at the reference point within the partial region. The processing of this flowchart is executed after the process of S402 illustrated in FIG. 4. After S402, the resolution setting unit 303 sequentially executes the processes of S801 and S802. S802 is followed by S1603, in which the resolution setting unit 303 selects a plurality of direction-specific pixel resolutions from among the pixel resolutions of the image capturing apparatuses 101 at the reference point, and sets the selected plurality of pixel resolutions as pixel resolutions for the partial region. After S1603, the resolution setting unit 303 terminates the processing of the flowchart illustrated in FIG. 16, i.e., the process of S403 according to the second embodiment.

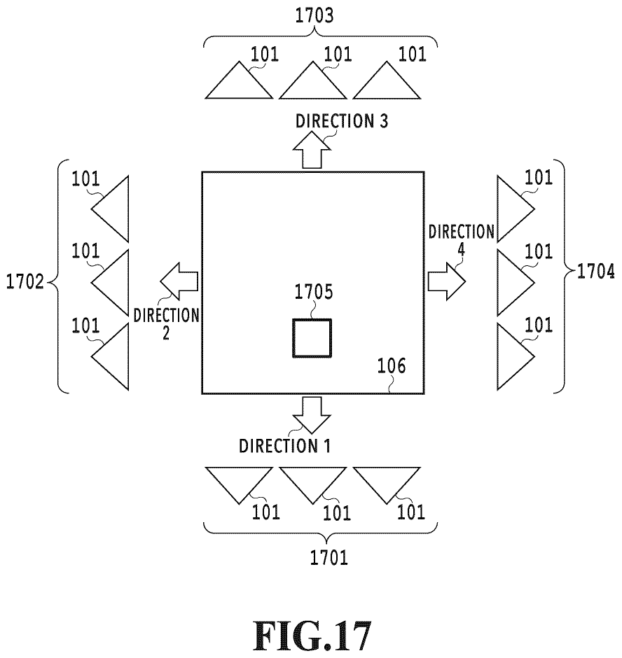

FIG. 17 is a diagram for describing an example of the pixel resolution setting processing by the resolution setting unit 303 according to the second embodiment. The present embodiment will be described below on the assumption that, as illustrated in FIG. 17, four image capturing apparatus groups 1701 to 1704 corresponding to four respective preset directions 1 to 4 have been defined with the image capturing apparatuses 101. Also, the present embodiment will be described on the assumption that the focal lengths of all image capturing apparatuses 101 are equal to one another. The resolution setting unit 303 sets a single pixel resolution per image capturing apparatus group. Specifically, first, for each image capturing apparatus group, the resolution setting unit 303 uses, for example, Equation (2) to calculate the pixel resolution of each image capturing apparatus 101 in the image capturing apparatus group at a reference point in a partial region 1705. Subsequently, for each image capturing apparatus group, the resolution setting unit 303 uses, for example, Equation (3) to select the highest pixel resolution among the pixel resolutions of the image capturing apparatuses 101 in the image capturing apparatus group (the smallest value among the resolution values rᵢ). Subsequently, the resolution setting unit 303 associates the selected pixel resolution with the direction of the image capturing apparatus group and sets it as the pixel resolution for the partial region.

### <Learning Model Setting Processing>

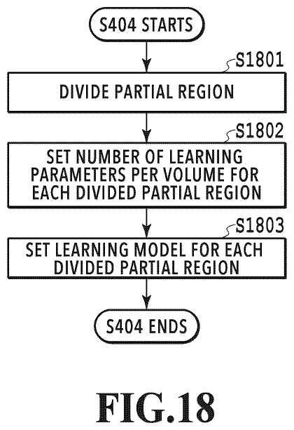

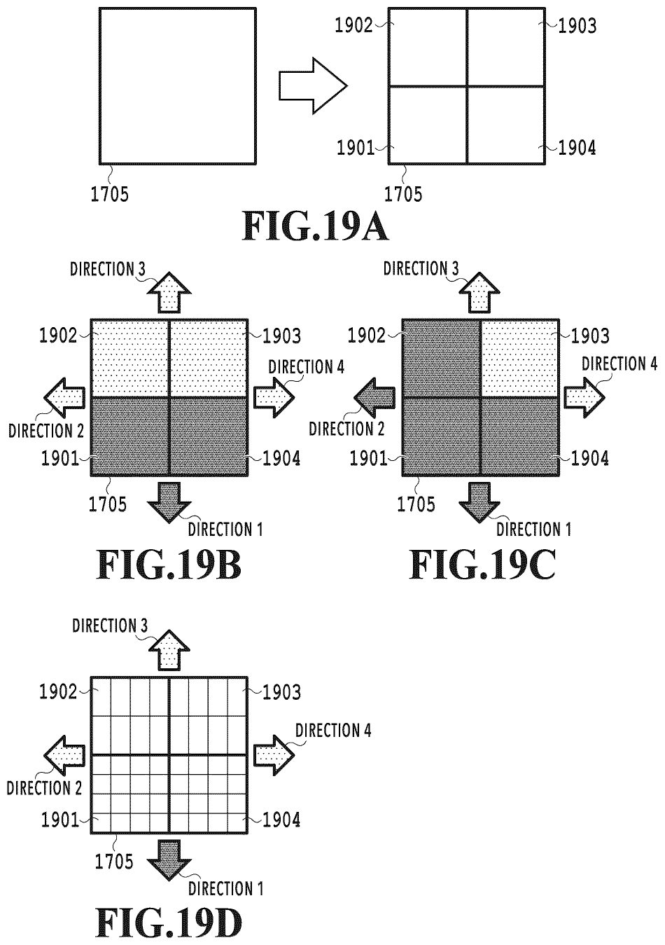

FIG. 18 is a flowchart illustrating an example of a flow of the learning model setting processing by the model setting unit 304 according to the second embodiment, and is a flowchart illustrating an example of a detailed flow of the processing in S404 illustrated in FIG. 4. S404 according to the second embodiment involves setting learning models based on the plurality of direction-specific pixel resolutions at the reference point within the partial region. The processing of this flowchart is executed after the process of S403 according to the present embodiment. FIGS. 19A to 19D are diagrams for describing an example of the learning model setting processing by the model setting unit 304 according to the second embodiment.

First, in S1801, the model setting unit 304 divides the partial region set in S402. Specifically, as exemplarily illustrated in FIG. 19A, the model setting unit 304 divides the partial region 1705 into four partial regions (hereinafter referred to as “divided partial regions”) 1901 to 1904, for example. Then, in S1802, the model setting unit 304 sets the learning parameter count per volume for each of the divided partial regions 1901 to 1904 obtained by the division in S1801 based on the plurality of direction-specific pixel resolutions set in S1603. Specifically, first, for each divided partial region, the model setting unit 304 sets the highest pixel resolution among the pixel resolutions associated with the directions corresponding to the divided partial region as the pixel resolution for the divided partial region. Subsequently, the model setting unit 304 sets the learning parameter count per volume such that the higher the set pixel resolution, that is, the smaller the resolution value rᵢ, the larger the number of layers per volume in the intermediate layer of the density MLP.

In the following, it is assumed that the divided partial region 1901 corresponds to the directions 1 and 2, the divided partial region 1902 corresponds to the directions 2 and 3, the divided partial regions 1903 corresponds to the directions 3 and 4, and the divided partial region 1904 corresponds to the directions 4 and 1. In a case where, for example, the partial region 1705 is positioned close to the image capturing apparatus group 1701 and far from the other image capturing apparatus groups, a high pixel resolution is set for the divided partial regions 1901 and 1904, which correspond to the direction 1, as illustrated in FIG. 19B. For the other divided partial regions 1902 and 1903, on the other hand, a low pixel resolution is set. Also, in a case where the partial region 1705 is positioned close to the image capturing apparatus groups 1701 and 1702 and far from the other image capturing apparatus groups, pixel resolutions as below are set for the divided partial regions. Specifically, in this case, as illustrated in FIG. 19C, a high pixel resolution is set for the divided partial regions 1901, 1902, and 1904, which correspond to the directions 1 and 2, and a low pixel resolution is set for the other divided partial region 1903.

S1802 is followed by S1803, in which, for each of the divided partial regions 1901 to 1904, the model setting unit 304 sets a learning model in which the learning parameter count set in S1802 is set. The processing for setting a learning model for each of the divided partial regions 1901 to 1904 in S1803 is similar to the processing for setting a learning model for the partial region in S1002 illustrated in FIG. 10.

As a result of the above processes, a learning model constructed by an MLP with a large number of layers per volume in the intermediate layer is set for each divided partial region corresponding to a direction with a high pixel resolution. A learning model constructed by an MLP with a small number of layers per volume in the intermediate layer is set for each divided partial region corresponding to a direction with a low pixel resolution.

### Advantageous Effect Provided by Image Processing Apparatus According to Second Embodiment

As described above, the image processing apparatus 102 according to the second embodiment sets a plurality of direction-specific pixel resolutions for the partial region 1705. Also, the image processing apparatus 102 according to the second embodiment sets a plurality of learning models differing in the total number of layers in the intermediate layer for the partial region 1705 based on the plurality of direction-specific pixel resolutions. The image processing apparatus 102 thus configured can estimate accurate three-dimensional information based on the direction-specific pixel resolutions while reducing the amount of computation required to estimate the three-dimensional information and the amount of information in the three-dimensional information. In particular, the image processing apparatus 102 can accurately estimate three-dimensional information of regions corresponding to directions for where image capturing apparatuses 101 have high pixel resolutions. This improves the image quality of virtual viewpoint images generated based on the estimated three-dimensional information.

### Modifications of Second Embodiment

It has been described that the resolution setting unit 303 according to the second embodiment divides a plurality of image capturing apparatuses 101 into four image capturing apparatus groups corresponding to four directions in the process of S1603, but the method of dividing the image capturing apparatuses 101 is not limited to this. For example, the number of directions by which to divide the plurality of image capturing apparatuses 101 into image capturing apparatus groups may be three or less or five or more. Also, the resolution setting unit 303 may divide the plurality of image capturing apparatuses 101 into a plurality of image capturing apparatus groups based on the image capturing parameters such that image capturing apparatuses 101 at similar positions and in similar orientations belong to the same image capturing apparatus group.

Also, it has been described that the model setting unit 304 according to the second embodiment divides the partial region 1705 into the four divided partial regions 1901 to 1904 in the process of S1801, but the method of dividing the partial region 1705 is not limited to this. The model setting unit 304 may divided the partial region 1705 into three or less divided partial regions or into five or more divided partial regions.

Also, it has been described that the model setting unit 304 according to the second embodiment sets a learning model for each of the divided partial regions 1901 to 1904 in the process of S1803, but the learning model setting method is not limited to this. For example, the model setting unit 304 may integrate a plurality of divided partial regions with the same pixel resolution and set a learning model for the divided partial regions thus integrated. Also, for example, the model setting unit 304 may set learning models with different learning parameter counts to the partial region 1705 before is divided, for regions corresponding to the divided partial regions 1901 to 1904. Specifically, for example, the model setting unit 304 locally changes grid intervals in a learning model constructed with learning parameters arranged in a grid pattern in a three-dimensional space as exemplarily illustrated in FIG. 14A, and sets the learning model after the change to the partial region 1705. In a case where, for example, the partial region 1705 is positioned close to the image capturing apparatus group 1701, the model setting unit 304 narrows the grid intervals at the region corresponding to the divided partial regions 1901 and 1904, which correspond to the direction 1, as exemplarily illustrated in FIG. 19D. Also, the model setting unit 304 sets, in the partial region 1705, a learning model with widened grid intervals at the region corresponding to the divided partial regions 1902 and 1903.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

It is possible to estimate three-dimensional information capable of generating virtual viewpoint images with high image quality while reducing the learning parameter count for the estimation of the three-dimensional information.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-101067, filed Jun. 24, 2024, which is hereby incorporated by reference herein in its entirety.

What is claimed is:

1. An image processing apparatus comprising:
one or more hardware processors; and
one or more memories storing one or more programs configured to be executed by the one or more hardware processors, the one or more programs including instructions for:
obtaining a plurality of captured images obtained by image capturing of an image capturing region from a plurality of directions;
setting at least one partial region in the image capturing region;
setting a learning model corresponding to the partial region such that the higher a pixel resolution for the partial region in each of the plurality of captured images, the larger the number of learning parameters per volume; and
training the learning model by using the plurality of captured images.

2. The image processing apparatus according to claim 1, wherein the one or more programs further include instructions for setting the learning model corresponding to the partial region such that the higher the pixel resolution for the partial region, the larger a total number of layers in an intermediate layer of the learning model.

3. The image processing apparatus according to claim 1, wherein the one or more programs further include instructions for setting the learning model corresponding to the partial region such that the higher the pixel resolution for the partial region, the larger the number of nodes included in a layer in an intermediate layer of the learning model.

4. The image processing apparatus according to claim 1, wherein the one or more programs further include instructions for setting the learning model corresponding to the partial region such that the higher the pixel resolution for the partial region, the smaller a learning region in the learning model.

5. The image processing apparatus according to claim 1, wherein the one or more programs further include instructions for setting the pixel resolution corresponding to the partial region based on image capturing parameters of the plurality of captured images.

6. The image processing apparatus according to claim 5, wherein the one or more programs further include instructions for setting the pixel resolution corresponding to the partial region based on a pixel resolution of one or more of the plurality of captured images in which a predetermined position in the partial region is not occluded.

7. The image processing apparatus according to claim 5, wherein the one or more programs further include instructions for setting a plurality of direction-specific pixel resolutions as the pixel resolution for the partial region.

8. The image processing apparatus according to claim 7, wherein the one or more programs further include instructions for setting the learning models with different numbers of learning parameters for a plurality of regions in the partial region based on the set plurality of direction-specific pixel resolutions.

9. The image processing apparatus according to claim 7, wherein the one or more programs further include instructions for setting the learning model that is based on the set plurality of direction-specific pixel resolutions for each of a plurality of regions in the partial region as the learning model corresponding to the partial region.

10. The image processing apparatus according to claim 1, wherein the one or more programs further include instructions for:
obtaining an approximate shape of an object present in the image capturing region; and
setting the partial region based on the approximate shape.

11. The image processing apparatus according to claim 1, wherein the learning model is information on a three-dimensional space in a learning region in the image capturing region.

12. The image processing apparatus according to claim 1, wherein the one or more programs further include instructions for:
obtaining information on a virtual viewpoint; and
generating a virtual viewpoint image corresponding to the virtual viewpoint by using the trained learning model.

13. An image processing method comprising the steps of:
obtaining a plurality of captured images obtained by image capturing of an image capturing region from a plurality of directions;
setting at least one partial region in the image capturing region;
setting a learning model corresponding to the partial region such that the higher a pixel resolution for the partial region in each of the plurality of captured images, the larger the number of learning parameters per volume; and
training the learning model by using the plurality of captured images.

14. A non-transitory computer readable storage medium storing a program for causing a computer to perform a control method of an image processing apparatus, the control method comprising the steps of:
obtaining a plurality of captured images obtained by image capturing of an image capturing region from a plurality of directions;
setting at least one partial region in the image capturing region;
setting a learning model corresponding to the partial region such that the higher a pixel resolution for the partial region in each of the plurality of captured images, the larger the number of learning parameters per volume; and
training the learning model by using the plurality of captured images.
